(19) United States
(12) Patent Application Publication
(10) Pub. No.: US 2025/0293574 A1
(43) Pub. Date: Sep. 18, 2025

(54) METHOD FOR PRODUCING A WINDING MAT FOR A STATOR OR A ROTOR OF AN ELECTRIC MOTOR

(71) Applicant: ZF FRIEDRICHSHAFEN AG, Friedrichshafen (DE)

(72) Inventors: Matthias EBERT, Himmelstadt (DE); Ralf SCHNEIDER, Werneck (DE)

(21) Appl. No.: 18/863,446

(22) PCT Filed: May 11, 2023
(86) PCT No.: PCT/EP2023/062587

§ 371 Date: Nov. 6, 2024

(30) Foreign Application Priority Data
May 17, 2022 (DE) 10 2022 204 826.1

(51) Int. Cl. H02K 15/043

(52) U.S. Cl. CPC H02K 15/043; H02K 2215/00

(57) ABSTRACT

A method for producing a winding mat for a stator or a rotor of an electric motor includes providing two conductor strands with at least one conductor in each instance; feeding the conductor strands in each instance to a receiving device along an X direction of a Cartesian coordinate system; simultaneously forming oppositely arranged winding heads at the two conductor strands, each forming a gable. A layer step is stamped in the gables preferably simultaneously. Subsequently, bars extending in opposite direction are formed before the receiving devices are detached from the conductor strands, and the conductor strands are transported by one conveying cycle. The above-mentioned steps are repeated until a winding mat with a defined quantity of windings comprising two winding heads and four bars, respectively, has been produced.

### CROSS REFERENCE TO RELATED APPLICATIONS

This is a U.S. national stage of Application No. PCT/EP2023/062587 filed May 11, 2023. Priority is claimed on German Application No. DE 10 2022 204 826.1 filed May 17, 2022 the content of which is incorporated herein by reference.

### BACKGROUND OF THE INVENTION

### 1. Field of the Invention

The present disclosure relates to a method for producing a winding mat for a stator or a rotor of an electric motor.

### 2. Description of the Related Art

The importance of electric motors has increased dramatically over the course of the transition to environmentally friendly energy and environmentally friendly mobility due to the rising demand for drives which are not dependent on fossil fuels. A conventional electric motor comprises a stator and a rotor. When current flows through the conductors wrapped around the rotor, a north pole and a south pole are formed and the rotor begins to rotate due to the external magnetic field of the stator. The type of winding for the stator and rotor plays an important role for the efficiency of the electric motor.

When winding the conductors to form a winding mat, which is fastened around or to the stator or rotor, the conductors are mechanically stressed. In order to ensure high efficiency, smooth running, a low noise level and high robustness of the electric motor, the winding process must be reproducible and cause the least possible mechanical stress on the conductors.

Further, a high stress on the conductor material during winding is also disadvantageous in that it brings about an increased expenditure on material during production.

There are various methods for producing a winding mat for a stator or a rotor. In general, one or more winding wires or conductors, which can be round wires or flat wires, for example, are fed via a feed device to a winding blade or a plug-in board and wound around the latter.

Winding around a plug-in board is disclosed in WO2019/130232 A1. Conductors and a plug-in board are provided for this purpose. The latter has slots for receiving the conductors. The conductors are provided by one or more wire guide devices. The conductors are inserted into the slots of the plug-in board such that portions of the conductors lie inside of the slot and other portions of the conductors project beyond the slots. Connections (winding heads) to the portions (bars) of the conductors to be fitted in the next slot are formed in each instance from the portions of the conductors projecting beyond the slots.

A winding process for multiple winding around a winding blade is described in DE 10 2004 035 084 A1. A template is required for the winding process. Bars that comprise n parallel wires and are located on the template and winding heads which extend beyond the template are produced on the template in a first work step. The winding heads are preferably produced in a V-shape or a gable shape by shaping bodies mounted on the template. After the bars and winding heads have been produced, they are displaced along a rotational axis of the template in a second work step by n-times the intermediate spacing. The first two work steps are repeated until a quantity of windings has been produced which corresponds to a quantity of rotor slots or stator slots.

A further winding method with a winding blade is described in U.S. Pat. No. 7,281,312 B2. The method is similar to the method described above but comprises, in addition, the transfer of the produced winding mat into a transfer tool, a rotor or a stator.

A substantial problem in the methods described above consists in the impossibility or economic infeasibility of adapting the dimensioning and transport (removal), especially with greater lengths of the winding mat, since the length of the plug-in board or winding blade substantially corresponds to the length of the winding mat to be produced.

A method for producing a winding mat with a winding blade is also described in EP 3 182 568 B2 in which individual wires or a plurality of wires are wound multiple times around a winding blade. Holders may be provided that hold a portion of the wires during the winding, while another portion of the wires is moved relative to it. However, the winding is not carried out to the point that a quantity of windings is achieved that corresponds to the quantity of rotor slots or stator slots. Instead, the wound wires are removed directly after winding via a transporting device which rotates with a winding device and which is formed as a belt conveyor or toothed belt conveyor. This has the advantage that the length of the winding mat to be produced can be flexibly adapted to a stator or a rotor.

In the described winding methods, the conductors are removed from the winding blade or plug-in board after winding and are subsequently pressed flat together. Pressing the winding mat or conductors together places a very severe stress on the insulation of the conductors. Moreover, when a rotating plug-in board or winding blade is used, a change in pitch is only possible to a limited degree. As a result, the parallel-wound conductors may be asymmetric with respect to one another and circulating currents may form. This leads to losses in the conductors during operation and does not contribute to torque formation.

### SUMMARY OF THE INVENTION

It is an object of one aspect of the invention to provide a winding method for producing a winding mat for a stator or a rotor of an electric motor without the use of a winding blade to cause less mechanical stress on the conductors and allow a greater flexibility in configuring the winding mat.

One aspect of the invention is a method for producing a winding for a stator or a rotor of an electric motor in which two conductor strands with at least one conductor in each instance are provided and are fed in each instance to a receiving device along an X direction of a Cartesian coordinate system, oppositely disposed winding heads are formed, each conductor strand being fed so as to form a gable with a first shaping tool having a gable-shaped cutout and a second shaping tool having a gable-shaped projection such that the conductor strands are bent in an X-Z plane, and a layer step is stamped in each instance in both gables in the opposite sense in a Y direction, bars running perpendicular to X direction in the X-Z plane are formed for each conductor strand, the bars are bent through the connection of the receiving devices to first shafts and the oppositely running movement of the first shafts toward one another in the opposite sense in a Z direction, the transfer of the conductor strands to second shafts and the oppositely running movement of the second shafts away from one another in the opposite sense in the Z direction, the receiving devices are detached and the conductor strands are transported in X direction by one conveying cycle in each instance, and the feed, the shaping of the winding heads, the shaping of the bars, the detachment of the receiving device and the transport of the conductor strands are repeated until a winding mat with a defined quantity of windings comprising in each instance two winding heads and four bars has been produced.

In order to avoid stressing the conductor material, it makes sense to omit a plug-in board or a winding blade. This has the advantage that winding mats can be produced in virtually any length and shape with a comparatively small mat width and mat height, and conductors can be inserted and removed flexibly during the process.

It is advantageous when the layer step is stamped during the bending of the conductor strands in the X-Z plane in the portions of the conductor strands forming the gables. The process can be accelerated in this way.

Additional stamping devices can be used for stamping the layer step, or stamping can be carried out with correspondingly constructed first shaping tools 3 and second shaping tools 4.

When forming the bars, a third shaping tool can advantageously be fed to the conductor strand in each instance and they can be bent around the third shaping tools to form the bars.

The first shaping tools and the second shaping tools can be exchanged during the process depending on the requirements of the winding mat in order to vary a pitch of the windings within the produced winding mat.

It is advantageous when the windings are transferred to a winding table which carries out a wobbling motion around the Z axis during the entire process in order to stamp the layer steps in the gables of the winding heads.

### BRIEF DESCRIPTION OF THE DRAWINGS

The invention will be described in more detail in the following through embodiment examples referring to drawings. The drawings show:

FIG. 1 is a view of a device for carrying out the method;

FIGS. 2A-H are individual method steps for producing a winding mat in a top view;

FIG. 3 is a plurality of windings of a winding mat with different pitches in a top view;

FIG. 4 is a view of a first shaping tool and a second shaping tool with a conductor strand for forming the winding heads;

FIG. 5 is a view of a conductor strand, a receiving device and a first shaft; and

FIGS. 6A-B are detail views of the stamping of the winding heads.

### DETAILED DESCRIPTION OF THE PRESENTLY PREFERRED EMBODIMENTS

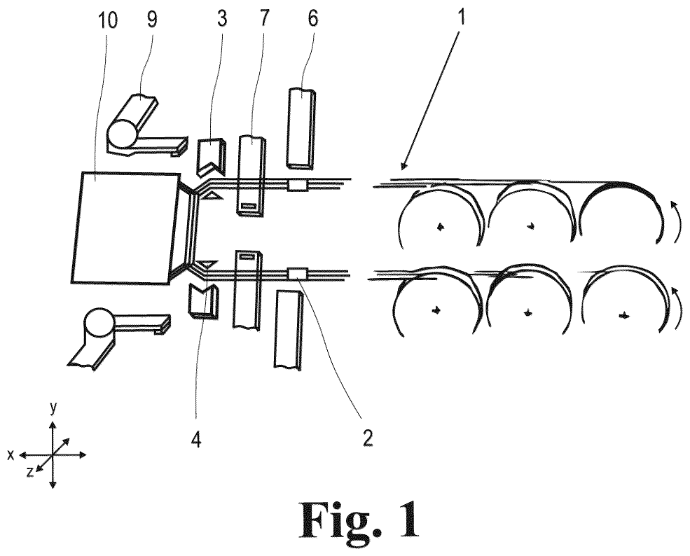

A view of a device for carrying out the method is shown in FIG. 1. Two conductor strands 1 are fed along the X direction of a Cartesian coordinate system to one of two receiving devices 2, respectively, in which the conductor strands 1 are fixed. The conductor strands 1 comprise at least one conductor in each instance, and the receiving devices 2, respectively, receive all of the conductors of a conductor strand 1. The two first shafts 6 and the two second shafts 7 are movable in opposite directions in Z direction and are connectable to the receiving devices 2 in each instance. In the embodiment shown in FIG. 1, the first shafts 6 are arranged above the conductor strands 1 and the second shafts 7 are arranged below the conductor strands 1. Two first shaping tools 3 are arranged to be movable in Z direction in opposite directions and second shaping tools 4 are arranged to be stationary. Third shaping tools 9 which are advantageously provided are arranged to be displaceable along all of the axes of the Cartesian coordinate system.

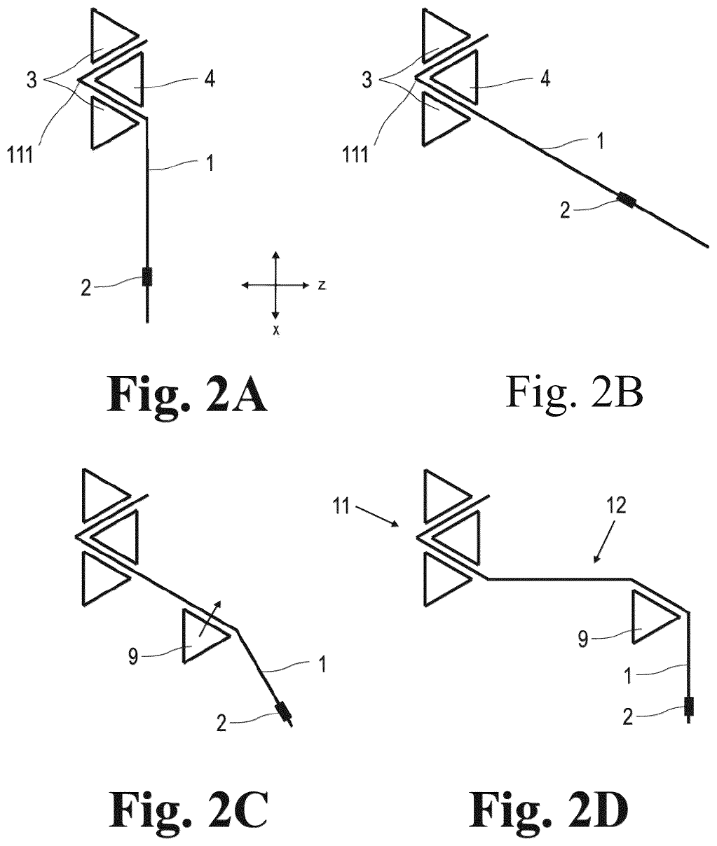

The winding process for a conductor strand 1 is shown in FIGS. 2a-h. The other winding strand 1 is simultaneously wound in an analogous manner with oppositely arranged winding heads 11. In order to form the winding head 11, the conductor strand 1 which is illustrated by one conductor by way of example is fed in each instance with a first shaping tool 3 having a gable-shaped cutout, a second shaping tool 4 having a gable-shaped projection so that the conductor strand 1 is bent in an X-Z plane forming a gable 111. Subsequently or simultaneously, a layer step 5 is stamped in the gable 111 of the winding head 11. In FIG. 2a, the winding head 11 is already formed and the receiving device 2 has received the conductor strand 1. FIGS. 2b-d show the shaping of a bar 12. The receiving device 2 is connected to the first shaft 6 (not shown), and the first shaft 6 is moved in Z direction, as a result of which the conductor strand 1 is bent in the X-Z plane. The receiving device 2 with the conductor strand 1 is subsequently transferred to a second shaft 7 (not shown), and a third shaping tool 9 is fed to the conductor strand 1. The second shaft 7 is likewise moved in Z direction, as a result of which the conductor strand 1 is further bent in X-Z plane, the bar 12 is formed, and the conductor strand 1 is bent around the third shaping tool 9.

The receiving device 2 is subsequently detached and the conductor strand 1 is moved in X direction by one conveying cycle. The conveying cycle advantageously corresponds to a pitch SW of the individual windings. The conductor strand 1 is now received by the other receiving device 2, and a winding head 11 is once again formed as is shown in FIG. 2e. FIGS. 2f-2h show the forming of a second bar 12 analogous to FIGS. 2b-d.

The described method steps are repeated until a winding mat 8 with a defined quantity of windings comprising, in each instance, two winding heads 11 and four bars 12 has been produced. The bars 12 are associated with two windings in each instance, except for the first bar 12 and last bar 12 of the winding mat 8.

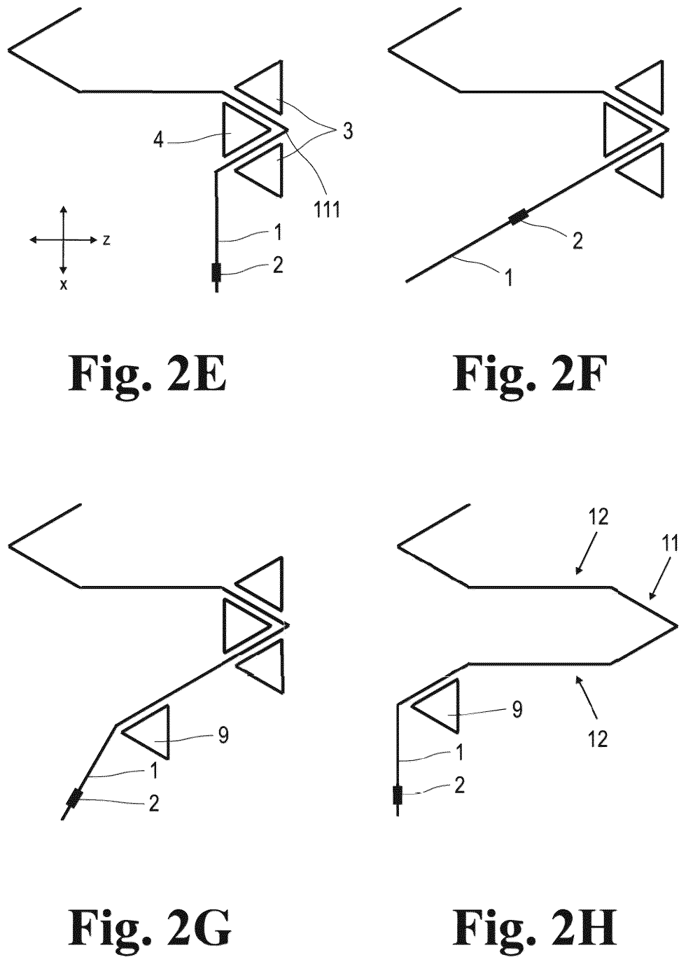

FIG. 3 shows a total of four windings, each of which comprises two opposing winding heads 11 and four bars 12, two bars 12 of which are situated one above the other in each instance. The first pitch SW₁ of the lower two windings differs from the second pitch SW₂ of the upper two windings. The pitch SW is the spacing between the two bars 12 of a winding. The pitch SW depends on the first shaping tools 3 and second shaping tools 4 used in the winding process as does the shape of the gables 111. These shaping tools 3, 4 may be exchanged over the course of the process so that the produced winding mat 8 can have windings with different pitches SW.

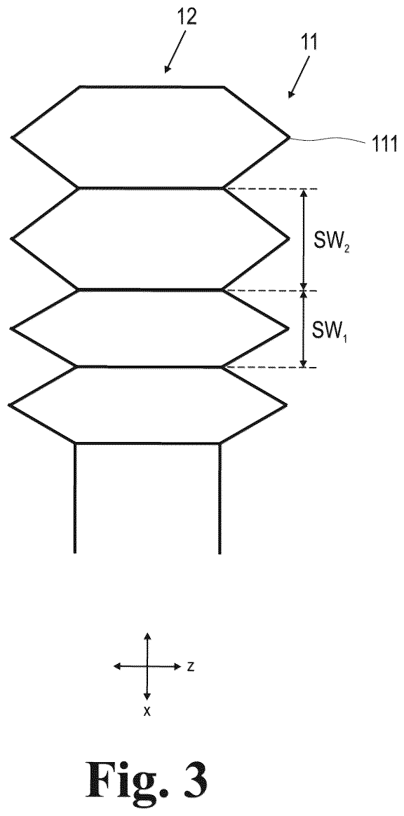

The forming of the winding head 11 is shown in a detail in FIG. 4. The first shaping tool 3 is movable, feeds the depicted conductor strand 1 to the stationary second shaping tool 4 and presses the conductor strand 1 against the second shaping tool 4. The gable-shaped winding head 11 is formed in this way.

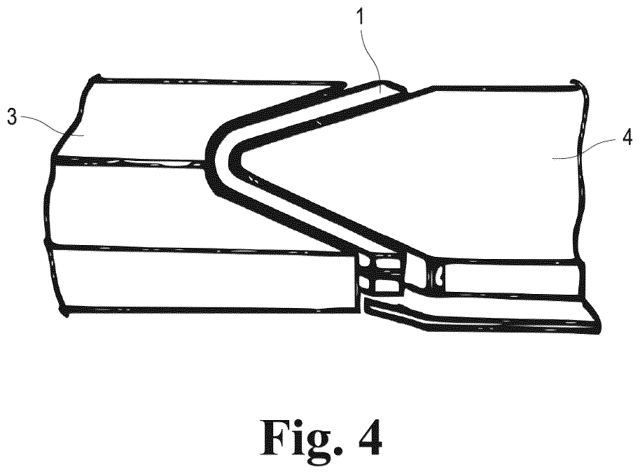

FIG. 5 shows, by way of example, the connection of the receiving device 2 that has received one of the conductor strands 1 to the first shaft 6. Additional connecting means can be provided at the receiving device 2 and/or at the first shaft 6 for this purpose. In a manner analogous to the first shaft 6, the receiving device 2 can also be connected to the second shaft 7. It is immaterial for the invention whether the shafts are arranged above or below the receiving device 2.

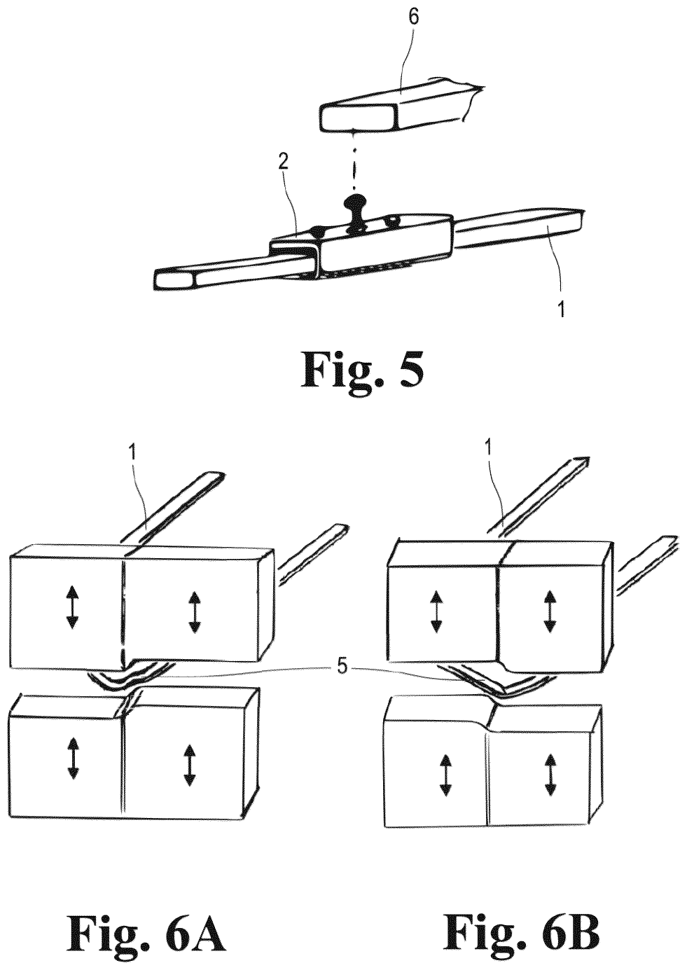

The stamping of a layer step 5 in each of the winding heads 11 is shown in a detail in FIG. 6a and FIG. 6b. Additional stamping devices can be used for stamping the layer step 5, or the stamping is carried out with correspondingly constructed first shaping tools 3 and second shaping tools 4. The layer step 5 describes a jump of the conductor strand 1 into another layer. Every wound conductor strand lies in two layers. The stamping can advantageously ensure, in addition, that the thickness of the conductor strand 1 or individual conductors of the conductor strand 1 decreases. The stamping makes it possible to interweave a plurality of conductor strands 1 or windings together to form the winding mat 8.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-5. (canceled)

6. A method of producing a winding mat for a stator or a rotor of an electric motor, comprising:
providing two conductor strands having at least one conductor in each instance;
feeding the two conductor strands in each instance to a receiving device along an X direction of a Cartesian coordinate system;
forming oppositely disposed winding heads, wherein the two conductor strands are fed in each instance with a first shaping tool with a gable-shaped cutout, a second shaping tool with a gable-shaped projection so that the two conductor strands are bent in an X-Z plane to form a gable, and a layer step is stamped in each instance in the two gables in an opposite sense in a Y direction;
shaping bars extending perpendicular to the X direction in the X-Z plane for each conductor strand, wherein the bars are bent through connection of the receiving devices with first shafts and oppositely running movement of the first shafts toward one another in the opposite sense in a Z direction;
transferring the two conductor strands to second shafts and the oppositely running movement of the second shafts away from one another in an opposite sense in the Z direction,
detaching the receiving device from the two conductor strands and transporting the two conductor strands in X direction by one conveying cycle; and
repeating until a winding mat with a defined quantity of windings formed in each instance by the two conductor strands and comprise in each instance two winding heads and four bars has been produced.

7. The method according to claim 6, wherein the layer step is stamped in the gables during bending of the conductor strands in the X-Z plane.

8. The method according to claim 7, wherein a third shaping tool is fed to the two conductor strands in each instance, and the two conductor strands are bent around the third shaping tools.

9. The method according to claim 6, wherein the first shaping tools and the second shaping tools are exchanged during to vary a pitch of the windings.

10. The method according to claim 6, wherein the windings are transferred to a winding table which carries out a wobbling movement around a Z axis to stamp the layer steps in the gables of the winding heads.
